(19) United States
(12) Patent Application Publication
(10) Pub. No.: US 2022/0332171 A1
(43) Pub. Date: Oct. 20, 2022

(54) VEHICLE WITH AIR BLOWING VENTS CARRIED BY THE FRONT SEATS

(71) Applicant: FAURECIA INTERIEUR INDUSTRIE, Nanterre (FR)

(72) Inventor: Frederic GREBER, ECOT (FR)

(21) Appl. No.: 17/722,327

(22) Filed: Apr. 16, 2022

(30) Foreign Application Priority Data
Apr. 16, 2021 (FR) FR21 03960

(51) Int. Cl. B60H 1/24; B60N 2/56; B60H 1/00

(52) U.S. Cl. CPC B60H 1/247; B60N 2/5628; B60N 2/5657; B60H 1/00564; B60H 1/00285

(57) ABSTRACT

A vehicle that includes a cabin air conditioning system, having a driver air distribution circuit provided with a plurality of driver blowing vents arranged to blow air directly into the driver's area. At least 75% of the driver blowing vents are carried by the driver's seat.

### TECHNICAL FIELD

The present invention relates in general to the thermal management of the cabin of a vehicle.

### BACKGROUND

Motor vehicles have an air conditioning system, which is designed to heat or cool the atmosphere inside the vehicle's cabin.

This system comprises a fan, at least one heating element, and usually at least one cooling element. An air mixing and distribution device distributes the air flow to different vents, distributed throughout the cabin.

The front of the vehicle typically has two vents at the base of the windscreen, four vents at the dashboard and two vents on the centre console that blow onto the feet of the vehicle's front passengers.

On the dashboard, there are two vents in the centre and two more on the side.

For example, the driver's area and the front passenger area are each served by three vents, which blow air directly into the corresponding area.

Some of the air introduced into the cabin passes through the cabin and escapes to the outside of the vehicle through a non-return valve in the rear fender. Another part of the air can be recycled upstream of the fan.

This recirculation reduces the amount of fresh air drawn in from the outside, thus reducing energy consumption to heat or cool the air blown into the cabin.

The recirculated air is drawn in through vents that are usually located under the dashboard, reaching the intake side of the fan. When a significant fraction of the air blown into the cabin is recycled, the air path is only marginally effective in conditioning the front of the cabin. The rear of the cabin is even less efficiently conditioned.

### SUMMARY

In this context, an object of the invention is to provide a motor vehicle in which the cabin is conditioned more efficiently.

To this end, the invention relates to a motor vehicle comprising:
a cabin with a driver's area in which there is a driver's seat;
an air conditioning system for the cabin, comprising a fresh air supply comprising at least one air blower and a driver's air distribution circuit;
the driver's air distribution circuit comprising a plurality of driver's blowing vents, fluidly connected to the at least one air blower and arranged to blow air directly into the driver's area;
at least 75% of the driver's blowing vents being carried by the driver's seat.

Because at least 75% of the driver's blowing vents are carried by the driver's seat, the air is blown as close to the driver as possible. Air from the driver's blowing vents flows around the seat occupant.

This helps ensure that the volume of the cabin around the driver is properly conditioned.

The motor vehicle may furthermore exhibit one or more of the following features, taken in isolation or in any combination that is technically possible:
each driver blowing vent is associated with a control member having an off position in which the air flow rate blown through said driver blowing vent is zero and a maximum flow rate position in which the air flow rate blown through said driver blowing vent is maximal, the driver air distribution circuit being configured so that, when the control member associated with each driver blowing vent is in its maximum flow rate position, at least 75% of a total air flow rate blown into the driver's area comes from the driver blowing vents carried by the driver's seat;
the air conditioning of the cabin comprises a stale air removal comprising a discharge opening to the outside of the vehicle and a driver's air outlet in fluid communication with the discharge, the driver's air outlet opening into the driver's area and being located in a floor or bulkhead, in front of the driver's seat;
the cabin having a front passenger area in which there is a front passenger seat, the fresh air supply comprising a front passenger air distribution circuit; the front passenger air distribution circuit comprising a plurality of front passenger blowing vents fluidly connected to the at least one air blower and arranged to blow air directly into the front passenger area; at least 75% of the front passenger blowing vents being carried by the front passenger seat;
the cabin has a rear passenger area in which there is at least one rear seat; the fresh air supply comprising a rear passenger air distribution circuit; the rear passenger air distribution circuit comprising a plurality of rear passenger blowing vents, fluidly connected to the at least one air blower and arranged to blow air directly into the rear passenger area; at least 75% of the rear passenger blowing vents being carried by the driver's seat or front passenger seat;
the stale air removal comprises a rear passenger air outlet in fluid communication with the outlet, the rear passenger air outlet opening into the rear passenger area and being carried by the at least one rear passenger seat;
the air conditioning of the cabin comprises a heat exchanger, with a first side arranged in the fresh air supply, and a second side arranged in the stale air discharge, the first side and the second side being in a heat exchange situation with each other;
the first side of the heat exchanger is arranged in the fresh air supply between the at least one air blower and the driver air distribution circuit;
the air conditioning of the cabin comprises a heater and a cooler arranged in the fresh air supply between the first side of the heat exchanger and the driver air distribution circuit, the at least one air blower, the heat exchanger, the heater and the cooler being aligned longitudinally;
the motor vehicle comprises a dashboard, the at least one air blower, the heat exchanger, the heater and the cooler being arranged in a space below the dashboard between the driver's seat and the front passenger seat;
the fresh air supply comprises a driver channel and a front passenger channel parallel to each other, fluidly connected to the driver air distribution circuit and the front passenger air distribution circuit respectively, the first side of the heat exchanger having a driver zone and a front passenger zone arranged in the driver channel and in the front passenger channel respectively, the heater comprising a driver heater and a front passenger heater arranged respectively in the driver channel and in the front passenger channel, and the cooler comprising a driver cooler and a front passenger cooler arranged respectively in the driver channel and in the front passenger channel.

### BRIEF DESCRIPTION OF THE DRAWINGS

Further features and advantages of the invention will be apparent from the detailed description given below, by way of indication and not in any way limiting, with reference to the appended figures, among which:

FIG. 1 is a top-view schematic depiction of a motor vehicle according to an embodiment of the invention;

FIG. 2 is a perspective view of the front passenger seat and the rear seat, showing the arrangement of the front passenger blowing vents, the front passenger exhaust vent, and the rear passenger air outlet;

FIG. 3 is a perspective view of the same elements as FIG. 2, taken at a different angle of incidence, showing a rear passenger blowing vent;

FIG. 4 is a perspective view of the air conditioning part of the cabin consisting of the blower, heat exchanger, heater and cooler; and

FIG. 5 is a view similar to FIG. 4, for a variant embodiment of the invention.

### DETAILED DESCRIPTION

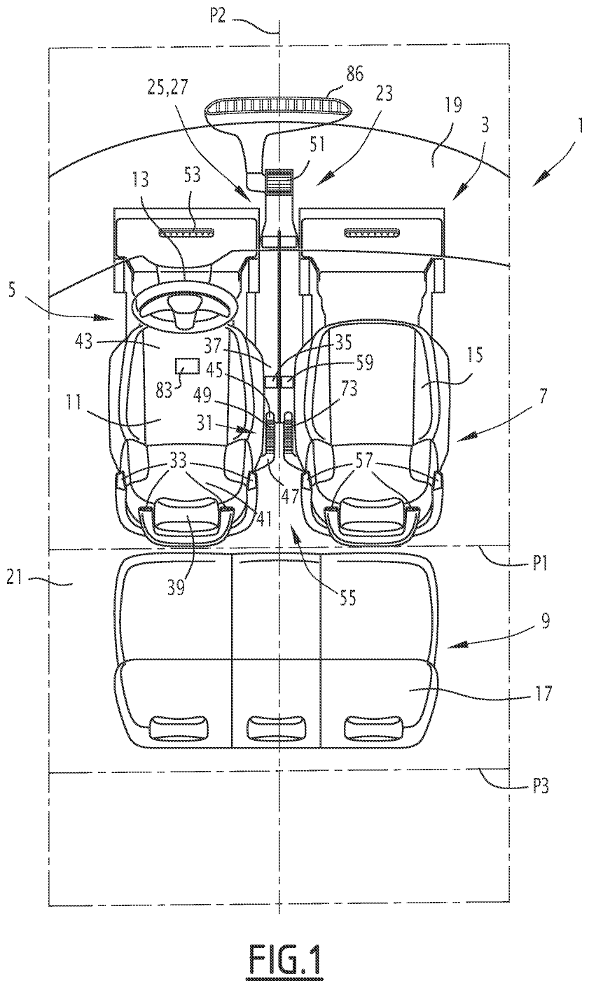

The vehicle 1 shown in FIG. 1 is a motor vehicle, typically a car. Alternatively, the vehicle 1 is a van, truck, bus, plane, boat, etc.

In this description, the longitudinal direction is the direction of travel of the vehicle, and the transverse direction is the direction perpendicular to the longitudinal direction and parallel to the running plane of the vehicle.

The vertical direction is understood here to be the direction perpendicular to the vehicle's plane of travel.

Front and rear shall be understood in relation to the normal direction of travel of the vehicle. Left and right are also understood in relation to the normal direction of travel of the vehicle.

Upstream and downstream are understood to be relative to the normal direction of flow of the corresponding fluid.

The motor vehicle 1 comprises a cabin 3 with a driver's area 5.

The cabin 3 also has a front passenger area 7.

It typically also comprises a rear passenger area 9.

A driver's seat 11 and a vehicle steering wheel 13 are located in the driver's area 5.

A front passenger seat 15 is located in the front passenger area 7.

At least one rear passenger seat 17 is located in the rear passenger area 9.

The rear passenger seat 17, in the example shown in the figures, is a bench comprising a plurality of seating places. Alternatively, the rear passenger area 9 is equipped with several rear passenger seats 17, independent of each other.

The driver's area 5 corresponds to the volume around the driver's seat 11.

The driver's area 5 is bounded towards the rear by a fictitious plane P1 containing the vertical and transverse directions, and passing substantially at the level of the driver's seat back 11.

The driver's area 5 is bounded towards the front by the bulkhead 18 separating the engine compartment from the cabin 3, and by the dashboard 19.

The driver's area 5 is bounded at the bottom by the floor 21 and at the top by the vehicle roof (not shown).

The driver's area 5 is bounded transversely on one side by the vehicle body (left-hand side for left-hand drive vehicles, right-hand side for right-hand drive vehicles), and on the opposite side by a fictitious plane P2 containing the vertical and longitudinal directions. This fictitious plane P2 is a longitudinal median plane of the vehicle.

The front passenger area 7 is similarly bounded. It is bounded towards the rear substantially by the fictitious plane P1, which passes through the back of the front passenger seat 15. It is bounded transversely on one side by the fictitious plane P2, and on the other side by the vehicle body.

The rear passenger area 9 is bounded towards the front by the fictitious plane P1, and towards the rear by a fictitious plane P3 passing through the backrest of the rear passenger seat(s) 17. The plane P3 is substantially vertical and transverse.

The rear passenger area 9 is bounded at the top by the vehicle roof and at the bottom by the floor 21. It is bounded transversely on both sides by the vehicle body.

The motor vehicle 1 comprises a cabin air conditioning system 23.

This air conditioning of the cabin 23 is designed to refresh the air in the cabin, and condition the air in the cabin 3. By condition, we mean heating or cooling the atmosphere in the cabin 3.

The air conditioning of the cabin 23 comprises a fresh air supply unit 25.

It also comprises a stale air removal 27.

Fresh air is defined here as air from outside the vehicle, which may be cold or warm.

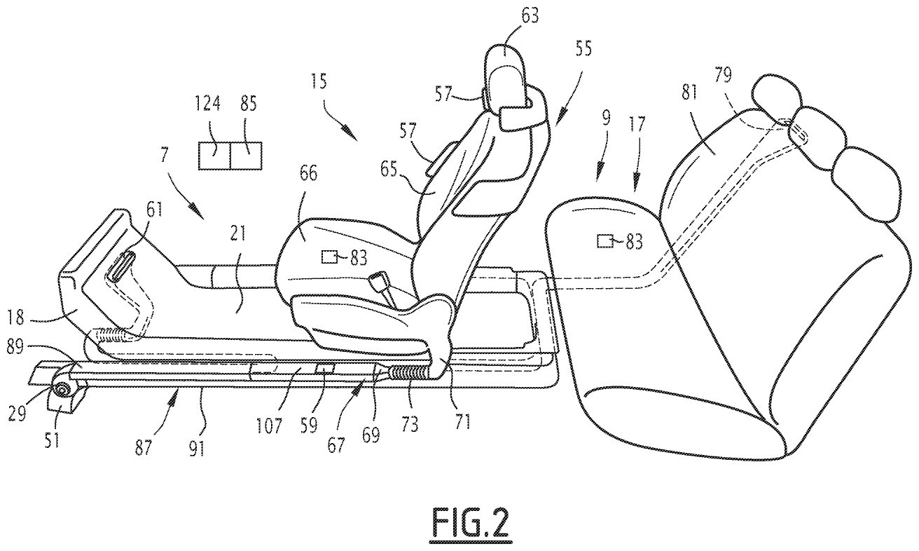

The fresh air supply unit 25 comprises at least one air blower 29 (FIG. 2) and a driver air distribution circuit 31 (FIG. 1).

The driver air distribution circuit 31 comprises a plurality of driver blowing vents 33, fluidly connected to the at least one air supply 29.

The driver blowing vents 33 are arranged to blow air directly into the driver's area 5.

Advantageously, at least 75% of the driver blowing vents 33 are carried by the driver's seat 11.

Typically, all the driver blowing vents are the blowing vents 33 carried by the driver's seat 11.

Alternatively, one or a small number of blowing vents blowing directly into the driver's area 5 may be provided on the dashboard 19 or on the centre console of the vehicle, or at other locations.

Thus, the air blown directly into the driver's area 5 comes mainly from the blowing vents 33 carried by the driver's seat 11.

More specifically, each driver blowing vent 33 is associated with a control member 35 having an off position in which the flow rate of air blown through said driver blowing vent 33 is zero, and a maximum flow rate position in which the flow rate of air blown through said blowing vent 33 is maximal.

The control member 35 is typically a shut-off member, arranged in a duct connecting the driver blowing vent 33 to the air blower 29. In the off position, the duct is completely closed. In the maximum flow position, the airflow area in the duct is as large as possible.

In the example shown, the fresh air supply 25 comprises a single control member 35, with all the driver blowing vents 33 being associated with the same control member. That control member is placed in a supply manifold 37, from which the air is distributed to the various driver supply vents 33.

When the control member 35 associated with each driver blowing vent 33 is in its maximum flow rate position, at least 75% of the total air flow rate of air blown through the driver blowing vents 33 into the driver's area 5 comes from the driver blowing vents 33 carried by the driver's seat 11.

Preferably, 100% of the total airflow through the driver blowing vents 33 in the driver's area 5 comes from the driver blowing vents 33 carried by the driver's seat 11.

The driver blowing vents 33 are carried by the driver's seat 11 in the sense that they are attached to it. They are attached to the outer surface of the seat as shown, or integrated into a seat component such as the seat bottom or backrest.

The driver's blowing vents 33 are arranged not to be blocked by the driver when sitting in the driver's seat 11, and to blow air forward. They are preferably placed transversely on either side of the driver, with some vents placed at the top of the seat.

In the example shown, the driver air distribution circuit 31 comprises four driver blowing vents 33, two arranged on either side of the headrest 39 of the driver's seat 11, and two arranged on either side of the backrest 41.

Alternatively, the driver air distribution circuit 31 has a different number of driver blowing vents 33, less than four or more than four.

These vents can be arranged in a variety of configurations. Some can be placed in the seat bottom 43, for example.

The driver blowing vents 33 are fluidly connected to the supply manifold 37 by ducts running within and/or on the surface of the driver's seat 11.

The supply manifold 37 comprises a fixed part 45 integral with the vehicle floor 21, a movable part 47 integral with the driver's seat 11, and a flexible hose 49 connecting the fixed part 45 to the movable part 47.

Thus, when the driver's seat 11 is moved longitudinally back and forth to accommodate the driver's driving position, the flexible hose 49 allows movement of the movable part 47 relative to the fixed part 45.

The stale air removal 27 comprises a discharge 51 leading to the exterior of the vehicle and a driver air outlet 53 in fluid communication with the discharge 51.

The discharge 51, in the example shown, opens under the vehicle. The driver air outlet 53 opens into the driver's area 5, typically directly into the driver's area 5. It is located in front of the driver's seat 11, in the floor 21 or in the bulkhead 18.

Typically, the stale air removal 27 comprises a single driver air outlet 53. Alternatively, it has a number of driver's blowing vents 53, all of which are located in front of the driver's seat 11 in the floor 21 or in the bulkhead 18.

The fresh air supply 25 also comprises a front passenger air distribution circuit 55, of the same type as the driver air distribution circuit 31.

The front passenger air distribution circuit 55 comprises a plurality of front passenger blowing vents 57, fluidly connected to the at least one air supply 29. They are arranged to blow air directly into the front passenger area 7.

At least 75% of the front passenger blowing vents 57 are carried by the front passenger seat 15, preferably 100% of the front passenger blowing vents 57.

Each front passenger blowing vent 57 is associated with a control member 59 having an off position in which the flow rate of air blown through said front passenger blowing vent 57 is zero, and a maximum flow rate position in which the flow rate of air blown through the front passenger blowing vent 57 is maximal.

In the example shown, the front passenger air distribution system 55 comprises a single control member 59 controlling the airflow to all front passenger blowing vents 57.

The front passenger air distribution circuit 55 is configured so that, when the control member 59 associated with each front passenger blowing vent 57 is in its maximum flow position, at least 75% of a total air flow blown through the front passenger blowing vents 57, and preferably 100%, is from the front passenger blowing vents 57 carried by the front passenger seat 15.

The stale air removal 27 comprises at least one front passenger air outlet 61 in fluid communication with the discharge 51. This front passenger air outlet 61 opens into the front passenger area 7, typically directly into the front passenger area 7. It is located in the floor 21 or in the bulkhead 18, in front of the front passenger seat 15.

The front passenger blowing vents 57 are arranged on the front passenger seat 15 in the same way as the driver blowing vents 33 on the driver's seat 11.

The front passenger air distribution system 55 comprises, for example, four front passenger blowing vents 57, two located on either side of the headrest 63, and two located on either side of the backrest 65.

Alternatively, the front passenger air distribution circuit 55 has a different number of front passenger blowing vents 57, less than four or more than four.

These vents can be arranged in a variety of configurations. Some can be placed in the seat bottom 66, for example.

The front passenger air distribution circuit 55 comprises a supply manifold 67, feeding the various front passenger blowing vents 57 via distribution ducts running in and/or on the surface of the front passenger seat 15.

The supply manifold 67 comprises a fixed part 69 integral with the vehicle floor 21, a movable part 71 integral with the front passenger seat 15, and a flexible duct 73 connecting the fixed and movable parts 69, 71 to each other.

The control member 59 is, for example, located in the supply manifold 67.

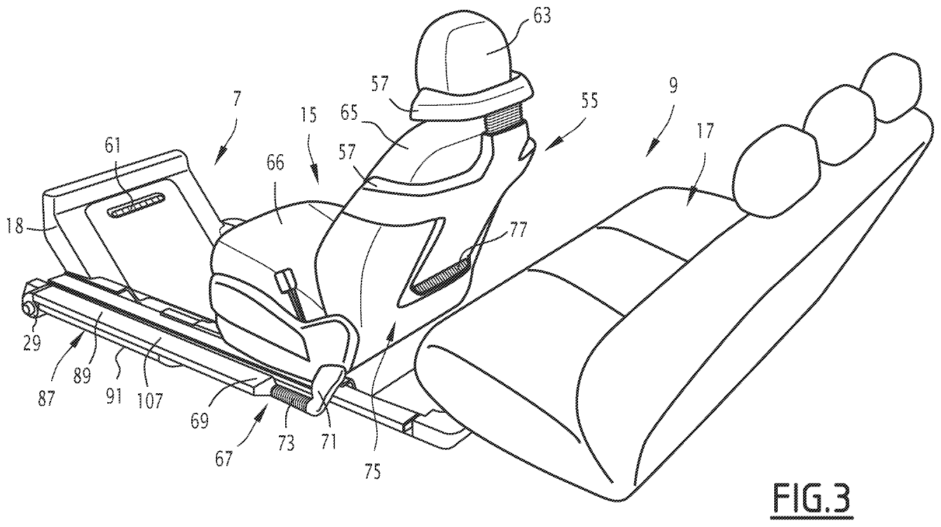

The fresh air supply 25 further comprises a rear passenger air distribution circuit 75 (FIG. 3).

The rear passenger air distribution circuit 75 comprises a plurality of rear passenger blowing vents 77, fluidly connected to the at least one air blower 29 and arranged to blow air directly into the rear passenger area 9.

At least 75% of the rear passenger blowing vents 77 being carried by the driver's seat 11 or front passenger seat 15. Typically, 100% of the rear passenger blowing vents 77 are carried by the driver's seat 11 or the front passenger seat 15.

In the example shown, the rear passenger air distribution system 75 has two rear passenger blowing vents 77, one carried by the driver's seat 11 and the other by the front passenger seat 15.

These vents are arranged in the respective backrests 41, 65 of these seats 11, 15 and blow air rearwards.

The rear passenger blowing vents 77 are connected to the air blower 29 via a manifold.

In an alternative, not shown, this manifold is dedicated to the rear passenger blowing vents 77. In such a case, it comprises, as described above, a fixed part integral with the floor, mobile parts integral with the driver and front passenger seats, and flexible tubes connecting the fixed part to the movable parts.

Alternatively, each rear passenger blowing vent 77 is supplied from the supply manifold 37 dedicated driver blowing vents 33 or from the supply manifold 67 dedicated to the front passenger blowing vents 57.

As before, each rear passenger blowing vent 77 is associated with a control member having at least one off position in which the flow rate of air blown through said rear passenger blowing vent 77 is zero, and a maximum flow rate position in which the flow rate of air blown through said rear passenger blowing vent 77 is maximal.

The stale air removal 27 comprises at least one rear passenger air outlet 79 in fluid communication with the discharge 51.

The at least one rear passenger air outlet 79 opens into the rear passenger area 9, typically opening directly into the rear passenger area 9, and is carried by the at least one rear passenger seat 17.

In the example shown, the or each rear passenger air outlet 79 is carried by the backrest 81 of the rear passenger seat 17 (FIG. 2).

Advantageously, the stale air removal 27 comprises two rear passenger air outlets 79, located transversely on two opposite sides of the rear passenger area 9.

When the rear passenger area 9 comprises a single seat, typically a bench extending across the entire transverse width of the vehicle, the two rear passenger blowing vents 79 are carried by the backrest 81 of this rear passenger seat 17.

When the rear passenger area 9 comprises a plurality of individual rear passenger seats 17, for example three individual seats, the two rear passenger blowing vents 79 are carried by the rightmost and the leftmost seat, respectively.

Advantageously, the control member associated with each blowing vent 33, 57, 77 is capable of adopting intermediate positions, making it possible to vary the quantity of air blown through the vent.

The front passenger seat 15 and/or the or each rear passenger seat 17 is equipped with a presence sensor 83 (FIG. 2), which detects whether a passenger is seated on said seat. This sensor 83 is of any suitable type. For example, it is a weight sensor.

The cabin air conditioning system 23 comprises a controller 85, informed by the sensor(s) 83. The controller 85 is programmed to operate the control member(s) associated with the blowing vents 57, 77, in accordance with the signal returned by the sensor(s) 83.

If the sensor 83 indicates that the corresponding seat is not occupied by a passenger, the controller 85 shall place the vent control member(s) associated with that seat in the off position.

This means that air is only blown into areas where there is a passenger in the seat.

Alternatively, the driver's seat 11 is also fitted with a presence sensor 83, the controller 85 controlling the control member(s) associated with the driver's blowing vents 33 in accordance with the signal returned by the sensor 83. The control unit(s) 35 are switched off if the driver's seat 11 is not occupied.

The cabin air conditioning system 23 comprises an air intake 86 (FIG. 1), opening to the outside of the vehicle. The air intake 86 is for example placed at the base of the vehicle windscreen. The air intake 86 is fluidly connected to the intake of the air blower 29.

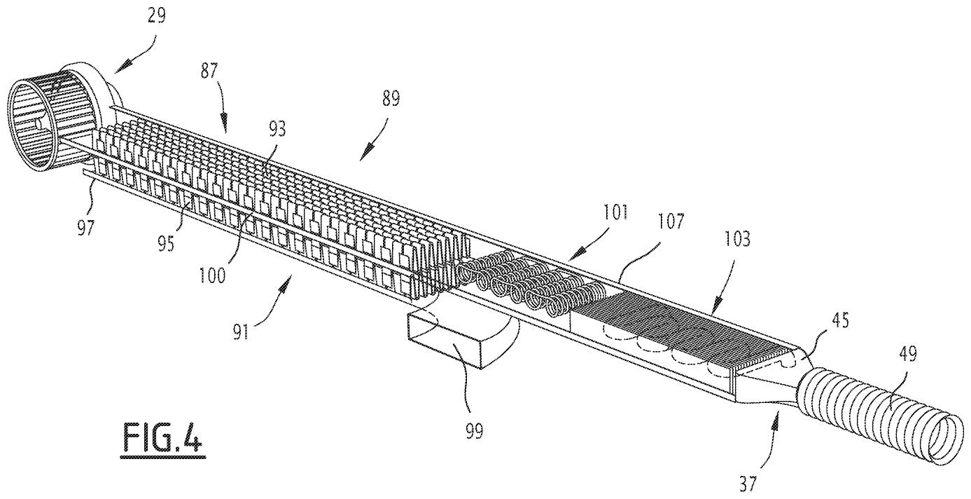

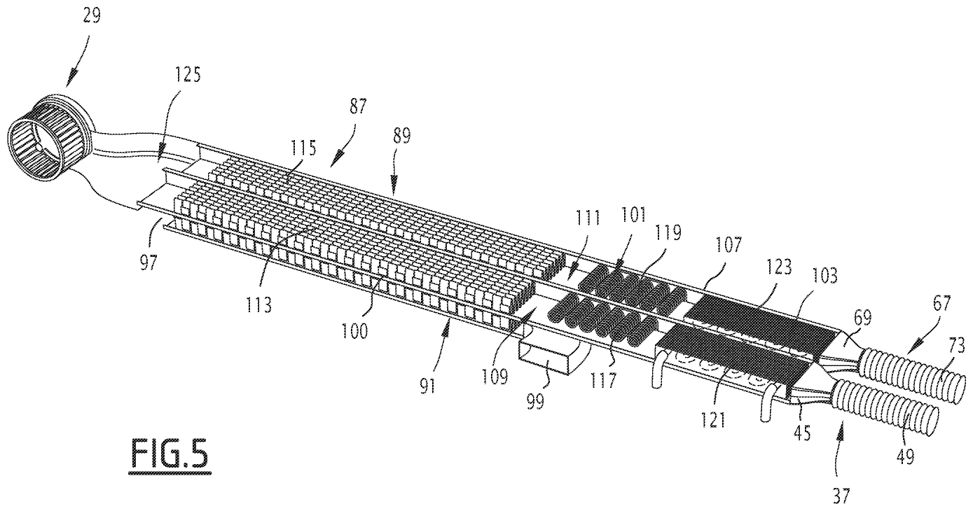

The air blower 29 is for example a squirrel cage fan, as shown in FIGS. 4 and 5.

Advantageously, the air conditioning of the cabin 23 comprises a heat exchanger 87.

The heat exchanger 87 comprises a first side 89 arranged in the fresh air supply 25, and a second side 91 arranged in the stale air removal 27.

The first side 89 and the second side 91 are in a heat-exchange situation with each other. In other words, the fresh air flowing through the first side 89 exchanges thermal energy with the stale air flowing through the second side 91.

When the cabin air conditioning system 23 heats the air in the cabin, the stale air gives up heat to the fresh air. Conversely, when the cabin air conditioning system 23 cools the air in the cabin, the fresh air flowing through the first side 89 gives up heat to the stale air flowing through the second side 91.

The first side 89 is arranged between the air blower 29 and the air distribution circuit(s) 31, 55, 75.

The heat exchanger 87 is straight, and longitudinally elongated.

The first side 89 is a straight, longitudinal duct. It is connected at one longitudinal end to the discharge outlet of the air blower 29. Longitudinal fins 93 are arranged in the first side 89, so as to facilitate heat exchange between the first and second sides 89, 91 of the heat exchanger 87.

The second side 91 of the heat exchanger 87 is also a longitudinal duct. Longitudinal vanes 95 are placed in the second side 91 to facilitate heat exchange with the first side 89.

One longitudinal end 97 of this longitudinal duct is connected to the discharge 51. An opposite longitudinal end 99 is fluidly connected to the or each driver air outlet 53. Typically, it is also connected to the or each front passenger air outlet 61 and/or the or each rear front passenger air outlet 79.

A wall 100 is shared by both longitudinal ducts and constitutes a heat exchange zone between the first side 89 and the second side 91.

The first side 89 and the second side 91 have exactly the same geometry, as the incoming fresh air flow is preferably the same as the outgoing stale air flow. The incoming fresh air and the outgoing stale air circulate in opposite directions through the heat exchanger 87.

The vanes 93, 95 are of any suitable type: they are for example of the offset type, or wave-shaped, or louvered.

For example, they are made of aluminium or copper. These materials have a high conductivity.

The cabin's air conditioning system 23 further comprises a heater 101 and a cooler 103, arranged in the fresh air supply 25 between the first side 89 of the heat exchanger 87 and the air distribution circuit(s) 31, 55, 75.

Advantageously, the air blower 29, the heat exchanger 87, the heater 101 and the cooler 103 are aligned longitudinally, as shown in FIG. 4.

They are arranged in that order, with the air blower 29 towards the front of the vehicle and the cooler 103 towards the rear of the vehicle.

Such an arrangement makes it possible to install these elements in a volume located at the base of the dashboard 19, between the driver's seat 11 and the front passenger seat 15. In other words, the assembly of air blower 29, heat exchanger 87, heater 101 and cooler 103 is placed between the driver's seat 11 and the front passenger seat 15, and immediately below the dashboard 19.

As seen in FIG. 4, the heater 101 and cooler 103 are located in a longitudinal duct 107, extending longitudinally from the first side 89 of the heat exchanger 87.

The duct 107 is straight, with the same cross-section as the duct forming the first side 89 of the heat exchanger 87.

In the case of an electric vehicle, the heater 101 is, for example, an electric resistor. Alternatively, the heater is a condenser forming part of a heat pump.

In the case of a motor vehicle with an internal combustion engine or fuel cell, the heater 101 is, for example, a heat exchanger in which the engine or fuel cell coolant circulates. Alternatively, it is an electrical resistor.

The cooler 103 is an evaporator, for example the evaporator of a heat pump.

The duct 107, downstream, is connected to at least the supply manifold 37 serving the driver air distribution circuit 31.

Typically, it is also connected to the supply manifold 67 serving the front passenger air distribution system 55, and/or the supply manifold serving the rear passenger air distribution system 75.

In FIG. 4, only the manifold 37 is shown.

According to the alternative embodiment shown in FIG. 4, the first side 89 of the heat exchanger 87 and the duct 107 in which the heater 101 and cooler 103 are arranged form a single duct, subsequently serving at least the driver air distribution circuit 31 and the front passenger air distribution circuit 55.

In the alternative embodiment shown in FIG. 5, the fresh air supply 25 comprises a driver channel 109 and a front passenger channel 111, parallel to each other, fluidly connected to the driver air distribution circuit 31 and the passenger air distribution circuit 55 respectively. The driver channel 109 and the front passenger channel 111 are completely separate from each other and do not communicate. Each has a front end, connected to the discharge of the air blower 29.

The first side 89 of the heat exchanger 87 has in this case a driver zone 113 and a front passenger zone 115, arranged in the driver channel 109 and in the front passenger channel 111 respectively. The driver's area 113 and the front passenger's area 115 are each in thermal contact with the second side 91 of the heat exchanger 87, the second side of the exchanger also being divided into two parts, each of these two parts being separately connected to the parts 113 and 115. Each zone 113, 115 has vanes.

The heater 101 comprises a driver heater 117 and a front passenger heater 119, which are arranged in the driver channel 109 and in the front passenger channel 111, respectively.

Similarly, the cooler 103 has a driver cooler 121 and a front passenger cooler 123 arranged in the driver channel 109 and the front passenger channel 111, respectively.

The controller 85 is configured to control the driver heater 117 and the front passenger heater 119 independently of each other. It is also configured to control the driver cooler 121 and the front passenger cooler 123 independently of each other.

The cabin air conditioning system 23 comprises in this case an interface 124 (FIG. 2), configured to allow the temperature of the air distributed by the driver air distribution system 31 and the temperature of the air distributed by the front passenger air distribution system 55 to be adjusted independently of each other.

Advantageously, the fresh air supply 25 comprises a three-way valve 125 arranged between the air discharge of the air blower 29 and the front ends of the channels 109, 111.

The three-way valve 125 is used to adjust the proportion of air delivered by the air blower 29 into each of the two channels 109, 111.

The three-way valve 125 is controlled by the controller 85, based on commands entered on the interface 124.

For example, the driver and front passenger coolers 121, 123 have variable pressures and expansion rates, which allows the evaporation temperature of the refrigerant gas, and thus the temperature of the air passing through the coolers, to be precisely adjusted. This system reduces the size of the coolers.

Alternatively, the driver cooler and the front passenger cooler 121, 123 are fixed-rate evaporators, in which case a bypass line is provided around each of the evaporators 121, 123. A three-way valve is associated with each evaporator 121, 123. The three-way valve is arranged to control the amount of air flowing into the bypass and the amount of air flowing into the evaporator. This allows the temperature of the air leaving the cooler to be adjusted.

In a variant not shown, the fresh air supply 25 has three parallel channels, each of the type described above with reference to FIG. 5. These three parallel channels serve the driver distribution system, the front passenger distribution system and the rear passenger distribution system.

In another embodiment, only the duct 107 is divided into two channels. The first side 89 of the heat exchanger 87 has only one channel, through which all the air from the air blower 29 flows. In this case, the distribution of the flows will be done either by means of the three-way valve 125, placed downstream of the first side 89 of the heat exchanger 87, so as to regulate the proportion of the air circulating in each of the two channels of the duct 107, or by means of the control members 35 and 59.

In another embodiment, the fresh air supply 25 comprises two air blowers 29, one of the two air blowers discharging into the driver channel 109 and the other into the front passenger channel 111.

This is another way of adjusting the amounts of air blown into the driver's area 5 and the front passenger's area 7 independently of each other.

In a further embodiment applicable to all modes, the first side of the heat exchanger is arranged in the fresh air supply upstream of the air blower, i.e. between the air intake and the air blower's suction. This variant is particularly well-suited to the configuration where the first side of the heat exchanger forms a single duct serving both the passenger air distribution circuit and the driver air distribution circuit, and is therefore not divided into two separate ducts serving the passenger air distribution circuit and the driver air distribution circuit.

The cabin's air conditioning system 23 does not comprise recirculation. In other words, it is not intended to recirculate any part of the stale air upstream of the air blower 29. The air flow rate supplied by the fresh air supply 25 into the cabin is always approximately equal to the air flow rate extracted by the stale air removal 27.

Such air recirculation is not necessary, due to the presence of the heat exchanger 87. This heat exchanger 87 recovers some of the heat energy from the stale air released outside the vehicle.

For example, in winter, with an outside temperature of −10° C. and an air temperature in the cabin of 20° C., for a heat exchange surface of 3.2 m² in each of the two sides of the heat exchanger 87 (surface of the vanes and of the shared wall 100), the temperature of the air leaving the first side 89 of the heat exchanger 87 is approximately 15° C. The temperature of the stale air leaving the second side 91 of the heat exchanger 87 is −5° C. The heat exchanger 87 thus advantageously has a temperature difference between its two sides of about 25° C., which is practically constant along the heat exchanger 87. Such a heat exchanger recovers about 300 W for an average air flow, which represents more than 70% of the energy effort needed to heat the cabin. In other words, the energy supplied by heating 101 is reduced to 90 W.

This example calculation corresponds to a medium-sized vehicle, running on a WLTP-type driving cycle, under regulatory driving conditions.

Under these conditions, a conventional vehicle, depending on the model, requires about one to two kW to heat the air in the cabin, depending on the recirculation rate and the thermal management of the cabin. This example shows the extent of the energy savings achieved by using the heat exchanger 87. This calculation does not take into account the fact that the blowing vents are very close to the bodies of the passengers, and that only the passengers present are heated.

The motor vehicle described above has many other advantages.

The fact that the driver blowing vents are carried by the driver's seat and the driver air outlet is provided in the floor or bulkhead, in front of the driver's seat, means that the air path always passes close to the driver's body, leading to a particularly suitable conditioning of the driver's area.

This effect is further enhanced by the fact that no air recirculation is provided in the air conditioning system.

The same benefits are achieved for the front passenger, as the front passenger blowing vents and the front passenger air outlet are arranged in the same way as for the driver.

Having the rear passenger blowing vents be carried by the driver's seat and front passenger seat allows rear passengers to benefit from air conditioning from a supply vent very close to them.

This effect is further enhanced by the fact that the rear passenger air outlet(s) are carried by the rear passenger seat(s). Once again, the air path passes close to the passengers' bodies.

As described above, by using a heat exchanger between the air flowing into the fresh air supply and the air flowing into the stale air removal, the energy requirements of the cabin air conditioning can be significantly reduced. This also eliminates the need to recirculate air upstream of the air blower. This means that the air in the cabin is always perfectly dry, and the CO2 emitted by the driver and potential passengers cannot stagnate in the cabin. The comfort of the vehicle occupants is increased.

As mentioned above, by aligning the air blower, heat exchanger, heater and cooler longitudinally, they can be placed at floor level between the two front seats. This frees up a lot of space in the dashboard.

When the fresh air supply comprises parallel channels dedicated to each distribution circuit, it is possible to adjust the blown air temperature in each zone of the vehicle, and possibly the air flow rate, independently.

It should be noted that the cabin's air conditioning system may include blowing vents for windscreen defogging. These defogging vents are located at the base of the windscreen. They do not blow directly into the driver's area or the front passenger's area.

1. A vehicle comprising:
a cabin having a driver's area in which a driver's seat is located;
a cabin air conditioning system, comprising a fresh air supply having at least one air blower and a driver air distribution circuit;
the driver air distribution circuit comprising a plurality of driver blowing vents, fluidly connected to the at least one air blower and arranged to blow air directly into the driver's area;
at least 75% of the driver blowing vents being carried by the driver's seat.

2. The vehicle according to claim 1, wherein each driver blowing vent is associated with a control member having an off position in which the air flow rate blown through said driver blowing vent is zero and a maximum flow rate position in which the air flow rate blown through said driver blowing vent is maximal, the driver air distribution circuit being configured so that, when the control member associated with each driver blowing vent is in its maximum flow rate position, at least 75% of a total air flow rate blown into the driver's area comes from the driver blowing vents carried by the driver's seat.

3. The vehicle according to claim 1, wherein the cabin's air conditioning system comprises a stale air removal comprising a discharge opening to the outside of the vehicle and a driver air outlet in fluid communication with the discharge, the driver air outlet opening into the driver's area and being located in a floor or bulkhead, in front of the driver's seat.

4. The vehicle according to claim 1, wherein the cabin has a front passenger area in which there is a front passenger seat, the fresh air supply comprising a front passenger air distribution circuit;
the front passenger air distribution circuit comprising a plurality of front passenger blowing vents fluidly connected to the at least one air blower and arranged to blow air directly into the front passenger area;
at least 75% of the front passenger blowing vents being carried by the front passenger seat.

5. The vehicle according to claim 1, wherein the cabin has a rear passenger area in which there is at least one rear passenger seat, the fresh air supply comprising a rear passenger air distribution circuit;
the rear passenger air distribution circuit comprising a plurality of rear passenger blowing vents fluidly connected to the at least one air blower and arranged to blow air directly into the rear passenger area;
at least 75% of the front passenger blowing vents being carried by the driver's seat or the rear passenger seat.

6. The vehicle according to claim 5, wherein the cabin's air conditioning system comprises a stale air removal comprising a discharge opening to the outside of the vehicle and a driver air outlet in fluid communication with the discharge, the driver air outlet opening into the driver's area and being located in a floor or bulkhead, in front of the driver's seat, wherein the stale air removal comprises a rear passenger air outlet in fluid communication with the discharge, the rear passenger air outlet opening into the rear passenger area and being carried by the at least one rear passenger seat.

7. The vehicle according to the claim 1, wherein the cabin's air conditioning system comprises a stale air removal comprising a discharge opening to the outside of the vehicle and a driver air outlet in fluid communication with the discharge, the driver air outlet opening into the driver's area (5) and being located in a floor or bulkhead, in front of the driver's seat, wherein the cabin air conditioning system comprises a heat exchanger, with a first side arranged in the fresh air supply, and a second side arranged in the stale air removal the first side and the second side being in a heat exchange situation with each other.

8. The vehicle according to claim 7, wherein the first side of the heat exchanger is arranged in the fresh air supply between the at least one air blower and the driver's air distribution circuit.

9. The vehicle according to claim 7, wherein the cabin air conditioning system comprises a heater and a cooler arranged in the fresh air supply between the first side of the heat exchanger and the driver's air distribution circuit, the at least one air blower, the heat exchanger, the heater and the cooler being aligned longitudinally.

10. The vehicle according to claim 9, wherein the motor vehicle comprises a dashboard, the at least one air blower, the heat exchanger, the heater and the cooler being arranged in a space below the dashboard between the driver's seat and the front passenger seat.

11. The vehicle according to claim 7, wherein the fresh air supply comprises a driver channel and a front passenger channel parallel to each other, fluidly connected to the driver air distribution circuit and the front passenger air distribution circuit respectively, the first side of the heat exchanger having a driver zone and a front passenger zone arranged in the driver channel and in the front passenger channel respectively, the heater comprising a driver heater and a front passenger heater arranged respectively in the driver channel and in the front passenger channel, and the cooler comprising a driver cooler and a front passenger cooler arranged respectively in the driver channel and in the front passenger channel.
